(19) United States
(12) Patent Application Publication
(10) Pub. No.: US 2025/0296831 A1
(43) Pub. Date: Sep. 25, 2025

(54) EQUINE SADDLE RACK AIR CUSHION

(71) Applicant: Heather R. Tillson, Burnaby (CA)

(72) Inventor: Heather R. Tillson, Burnaby (CA)

(21) Appl. No.: 18/613,057

(22) Filed: Mar. 21, 2024

(51) Int. Cl. B68C 1/12; B68C 1/00

(52) U.S. Cl. CPC B68C 1/12; B68C 1/002

(57) ABSTRACT

A device for cushioning between a saddle and a saddle rack includes an elongated spine and a pair of cushion portions extending from opposite lateral sides of the elongated spine. The equine saddle rack air cushion is an inflatable and adjustable protective barrier that lays between a saddle, particularly an English style saddle, and a saddle rack to prevent denting and distortion to the wool flocking and/or foam panels in the English style saddle, thereby maintaining the custom fit thereof.

### BACKGROUND OF THE INVENTION

The following includes information that may be useful in understanding the present disclosure. It is not an admission that any of the information provided herein is prior art nor material to the presently described or claimed inventions, nor that any publication or document that is specifically or implicitly referenced is prior art.

### TECHNICAL FIELD

The present invention relates generally to the field of equine saddles and accessories of existing art and more specifically relates to an inflatable cushion for protecting a saddle stored on a saddle rack.

### RELATED ART

A saddle is a specialized seat designed for riders, crafted to fit securely on a horse's back and provide a comfortable and stable platform for riders to sit while horseback riding. Saddles are provided in various styles, each tailored to a specific equestrian discipline and/or a preferred style of the rider. For example, English-style saddles are tailored to accommodate a close contact between the rider and the horse. English-style saddles are typically filled with raw wool and/or foam panels customized to conform to the unique shape of a specific horse's back and withers.

Saddles, when not in use, are typically stored on saddle racks-a support structure designed to hold the saddle to help maintain the saddle's shape. However, these saddle racks can pose a problem, especially for English-style saddles, as prolonged resting on rigid saddle racks can lead to dents and distortions in the customized fitting of the saddle. This is not only an expensive fix but can cause pain and discomfort to the horse and rider due to an improper fit. Accordingly, a suitable solution is desired.

### SUMMARY OF THE INVENTION

In view of the foregoing disadvantages inherent in the known equestrian saddle art, the present disclosure provides a novel equine saddle rack air cushion. The general purpose of the present disclosure, which will be described subsequently in greater detail, is to provide a device that can be placed in between a saddle and a saddle rack for protecting the saddle and preventing deformation thereof, thereby maintaining a proper fit of the saddle to prevent injury to the horse's back and shoulder.

A device for cushioning between a saddle and a saddle rack is disclosed herein. In some embodiments, the device may include an elongated spine configured for placement between a center of the saddle rack and a seat of the saddle. In some embodiments, the elongated spine may include a first non-slip material located at a bottom surface thereof. A pair of cushion portions may be attached at opposite lateral sides of the elongated spine. In some embodiments, the pair of cushion portions may be pivotably attached to the elongated spine.

A first cushion portion of the pair of cushion portions may be configured for placement between a first side of the saddle rack and a first side of the saddle; and a second cushion portion of the pair of cushion portions may be configured for placement between a second side of the saddle rack and a second side of the saddle. The pair of cushion portions may each include at least one interior air pocket, at least one air valve and at least one air channel configured to carry air introduced at the at least one air valve to the at least one interior air pocket, enabling the at least one interior air pocket to be filled with a desired level of air, thereby inflating the pair of cushion portions. In some embodiments, the pair of cushion portions may each include a second non-slip material at a bottom side thereof.

According to another embodiment, a method for cushioning between a saddle and a saddle rack is also disclosed herein. The method may comprise the steps of: providing the device as above; placing the device over the saddle rack, oriented such that the elongated spine is positioned over a center of the saddle rack, a first cushion portion of the pair of cushion portions is positioned at a first side of the saddle rack, and a second cushion portion of the pair of cushion portions is positioned a second side of the saddle rack; introducing air through the at least one air valve on each of the pair of cushion portions, the air being carried through the at least one air channel of each of the pair of cushion portions and into the at least one interior air pocket of each of the pair of cushion portions, thereby inflating each of the pair of cushion portions; and placing the saddle over the device, oriented such that the elongated spine is positioned under a seat of the saddle, the first cushion portion is positioned under a first side of the saddle, and the second cushion portion is positioned under a second side of the saddle.

For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures which accompany the written portion of this specification illustrate embodiments and methods of use for the present disclosure, an equine saddle rack air cushion, constructed and operative according to the teachings of the present disclosure.

FIG. 1 is a perspective view of a device placed between a saddle rack and a saddle for cushioning the saddle, according to one or more embodiments of the disclosure.

FIG. 2 is an exploded perspective view of the device, the saddle and the saddle rack, according to one or more embodiments of the disclosure.

FIG. 3 is a side view of the device and illustrating a cushion portion thereof, according to one or more embodiments of the disclosure.

FIG. 4 is a top perspective view of the device including an elongated spine and a pair of the cushion portions, according to one or more embodiments of the disclosure.

FIG. 5 is a side perspective view illustrating a cushion portion including three interior air pockets and two air channels, according to one or more embodiments of the disclosure.

FIG. 6 is a bottom perspective view illustrating the elongated spine and the pair of cushions including non-slip material, according to one or more embodiments of the disclosure.

FIG. 7 is a side perspective view illustrating the device inverted and illustrating a rear of each cushion portion including an air valve, according to one or more embodiments of the disclosure.

FIG. 8 is a flow diagram illustrating a method of cushioning between a saddle and a saddle rack, according to one or more embodiments of the disclosure.

The various embodiments of the present invention will hereinafter be described in conjunction with the appended drawings, wherein like designations denote like elements.

### DETAILED DESCRIPTION

As discussed above, embodiments of the present disclosure relate to an equine saddle rack air cushion. Generally, the equine saddle rack air cushion may include an inflatable, adjustable cushion that lays between a saddle (particularly an English style saddle) and a saddle rack to act as a protective barrier for the saddle. The equine saddle rack air cushion particularly prevents denting and distortion to custom wool flocking and/or foam panels in the English style saddle, thereby maintaining the custom fit thereof.

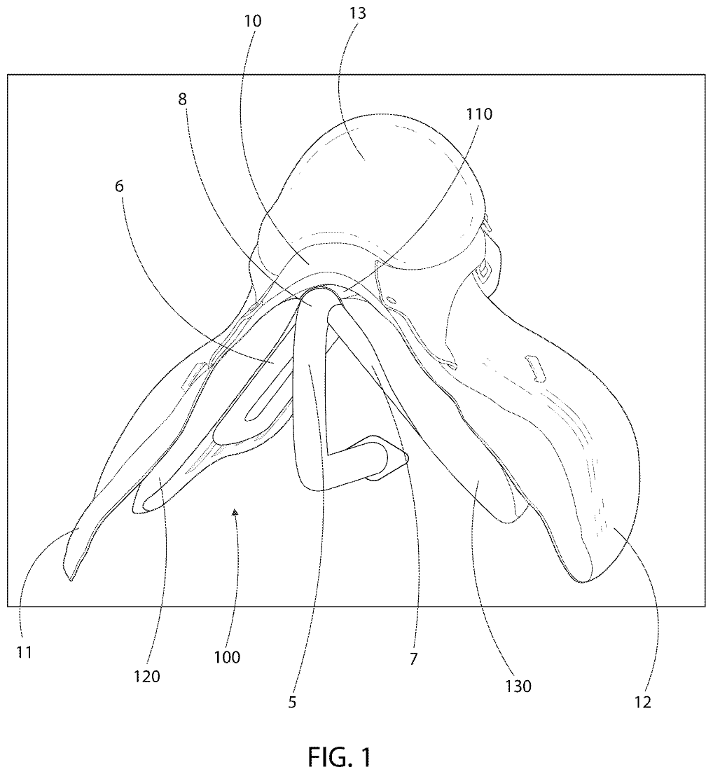

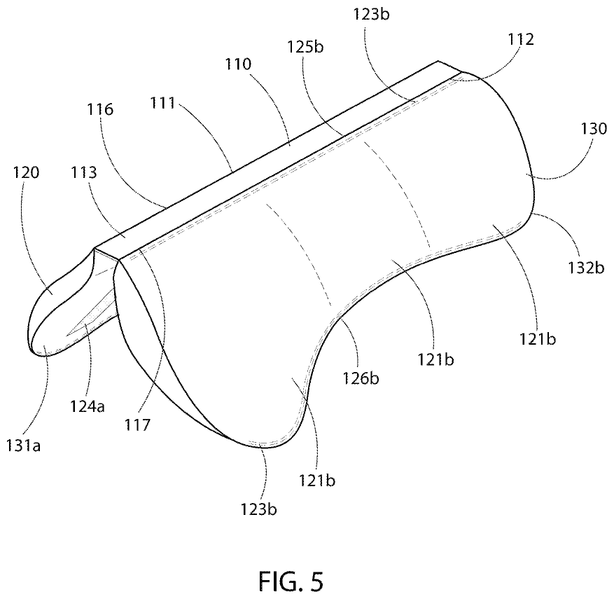

Referring now more specifically to the drawings by numerals of reference, there is shown in FIGS. 1-7, various views of a device 100 for cushioning between a saddle rack 5 and a saddle 10.

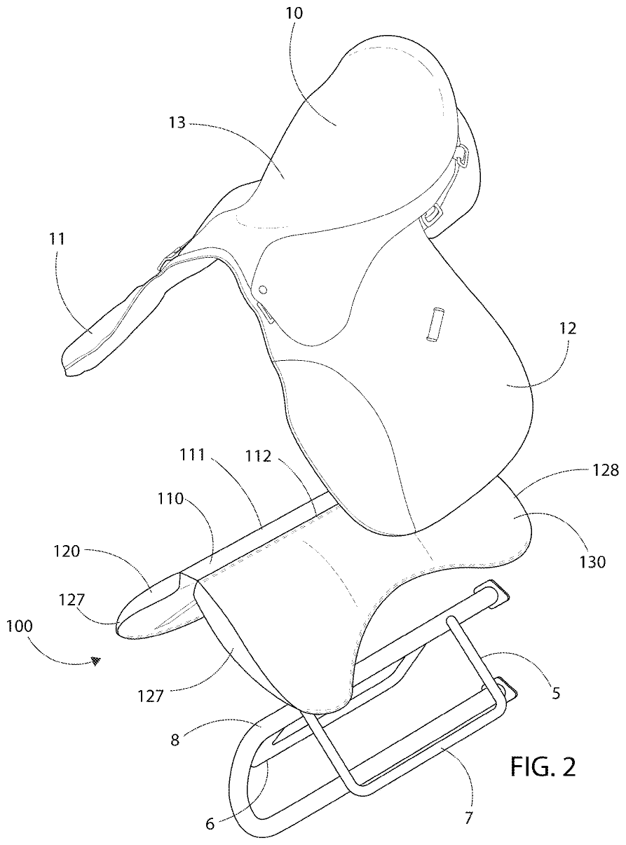

Beginning first with FIGS. 1-2, there is shown the device 100 in relation to the saddle rack 5 and the saddle 10. Particularly FIG. 1 demonstrates the device 100 placed between the saddle rack 5 and the saddle 10 to provide cushioning and support to the saddle 10. FIG. 2 demonstrates an exploded view of the device 100 between the saddle 10 and the saddle rack 5 to clearly demonstrate preferred placement of the device 100 between the saddle 10 and the saddle rack 5, according to one or more embodiments.

As shown in these figures, the device 100 may be particularly suited for English-style saddles 10. The saddle rack 5 may be any saddle rack 5, however, the device 100 may be particularly useful for especially rigid saddle racks 5, such as those constructed from hard wood or metal, which would otherwise (without the device 100) cause damage and deformation to the saddle 10. It should be appreciated that the saddle rack 5 and saddle 10 depicted in the figures are provided as examples only to aid in understanding of the invention and do not limit use of the invention to these particular racks 5 or saddles 10.

As shown here, the device 100 may include an elongated spine 110 configured for placement between a center 8 of the saddle rack 5 and a seat 13 of the saddle 10. In some embodiments, the elongated spine 110 may be longitudinally flexible. This may allow the elongated spine 110 to conform to variously sized and shaped saddle racks 5, ensuring that the device 100 remains stable over the saddle rack 5, thus keeping the saddle 10 stable over the device 100.

Further, a pair of cushion portions 120, 130 may be attached at opposite (lateral) sides of the elongated spine 110. For example, a first cushion portion 120 of the pair of cushion portions 120, 130 may be located at a first lateral side 111 (e.g., a left side) of the elongated spine 110; and a second cushion portion 130 of the pair of cushion portions 120, 130 may be located at a second lateral side 112 (e.g., a right side) of the elongated spine 110.

As shown here, the first cushion portion 120 may be configured for placement between a first side 6 of the saddle rack 5 and a first side 11 of the saddle 10 (e.g., a left side of the saddle rack 5 and a left side of the saddle 10). Similarly, the second cushion portion 130 may be configured for placement between a second side 7 of the saddle rack 5 and a second side 12 of the saddle 10 (e.g., a right side of the saddle rack 5 and a right side of the saddle 10). Accordingly, the cushion portion 120 and the second cushion portion 130 provide support and cushioning to the first and second side 11, 12 of the saddle 10.

In some embodiments, the cushion portions 120, 130 may be (but are not limited to being) equal mirror images of each other, and as such, it may be contemplated that the positioning of the device 100 is interchangeable; for example, the first cushion portion 120 may be placed between the second sides 7 and 12 of the saddle rack 5 and saddle 10, respectively, or vice versa.

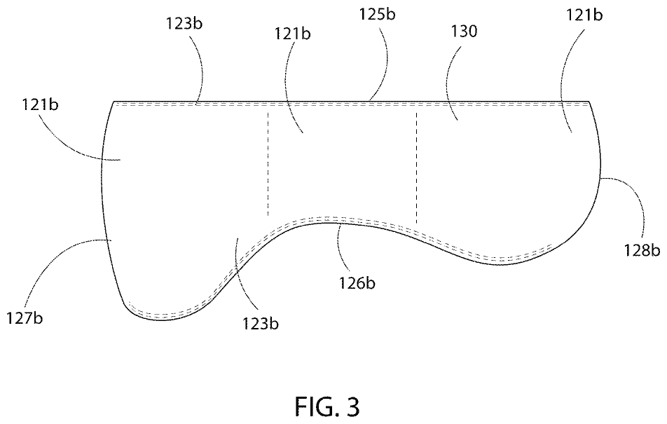

Each of the first cushion portion 120, the second cushion portion 130 and the elongated spine 110 may include shapes and sizes able to adequately support the saddle 10. In some examples, as shown, the elongated spine 110 is extended and may include (but is not limited to) a length of 18 inches and a width of 2 inches. Further, as demonstrated more specifically in FIG. 3, in some examples, each cushion portion 120, 130 may include (but is not limited to) a height of 8 inches toward a rear edge 128 a, 128 b thereof, a height of 10 inches toward front edge 127 a, 127 b thereof and a general length of 18 inches as measured from the front edge 127 a, 127 b to the rear edge 128 a, 128 b.

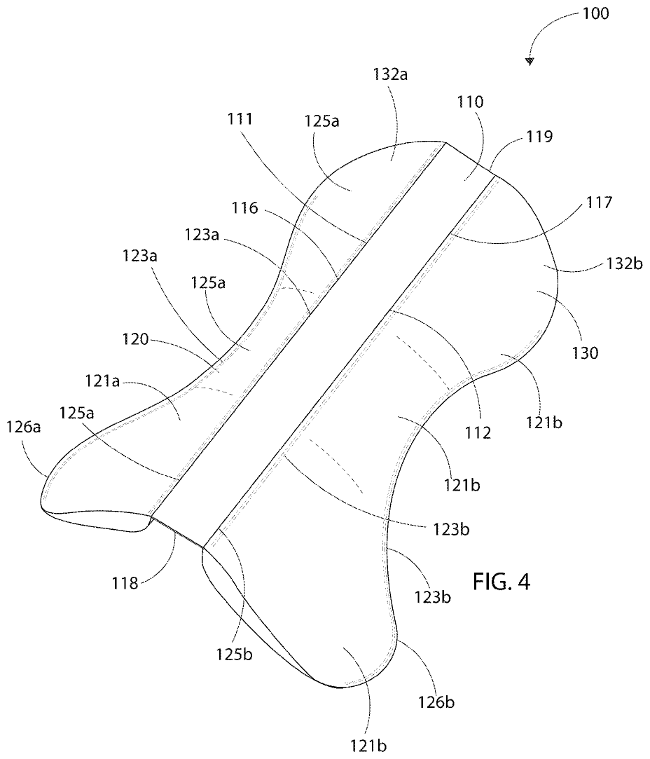

Referring now more specifically to FIGS. 3-7, there are shown various perspective views of the device 100, according to one or more embodiments of the present disclosure. As above, the pair of cushion portions 120, 130 may be attached at opposite sides 111, 112 of the elongated spine 110. As shown particularly in FIG. 4, the elongated spine 110 may define a top of the device 100, and each of the pair of cushion portions 120, 130 may extend downwardly therefrom.

In some embodiments, the pair of cushion portions 120, 130 may be hinged, or pivotably attached, to the elongated spine 110. This may enable the cushion portions 120, 130 to flex and accommodate variously sized and shaped saddle racks 5, ensuring that the device 100 remains stable over the saddle rack 5, thus keeping the saddle 10 stable over the device 100.

As shown in FIGS. 3-5, the pair of cushion portions 120, 130 may each include a top edge 125 a, 125 b pivotably attached to (opposite) lateral edges 116, 117 at either side 111 and 112, respectively, of the elongated spine 110. Opposite the top edge 125 a, 125 b may be a bottom edge 126 a, 126 b. In some embodiments, the top edge 125 a, 125 b may be substantially straight and the bottom edge 126 a, 126 b may include a curvature, defining the differently sized heights toward the front edge 127 a, 127 b and the rear edge 128 a, 128 b, as discussed above. FIG. 3 demonstrates this difference in height on the second cushion portion 130; however, again it is contemplated that the cushion portions 120, 130 may be equal mirror images of each other.

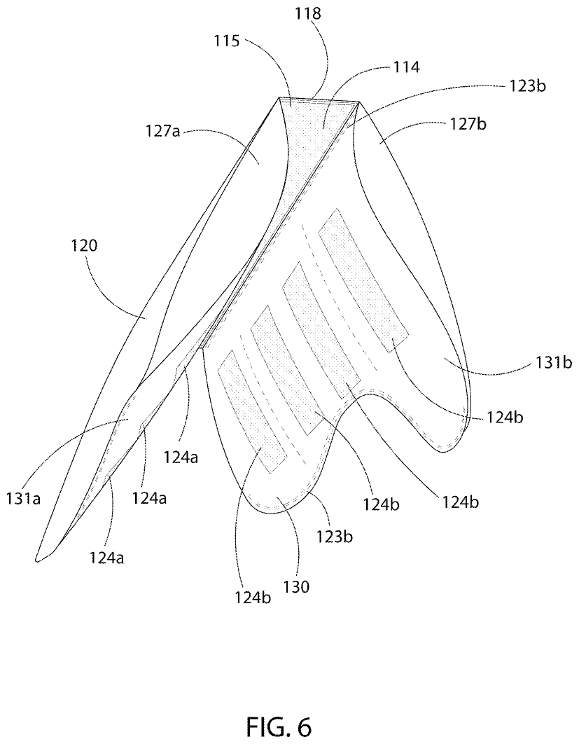

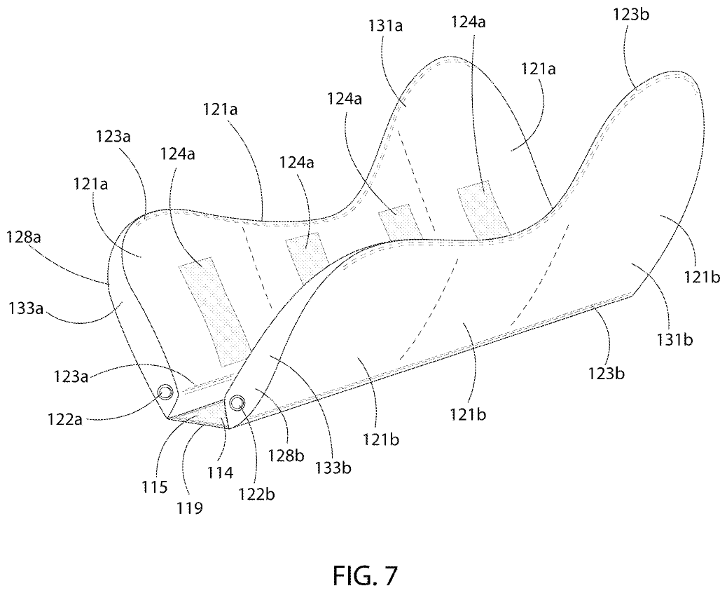

As shown in these figures, the elongated spine 110 may be substantially flat and longitudinally flexible (as discussed above), allowing easy placement of the device 100 over the saddle rack 5. The elongated spine 110 may include the first lateral edge 116, the second lateral edge 117, a front edge 118 and a rear edge 119 opposite the front edge 118, defining the length of the elongated spine 110 therebetween. A weight of the cushion portions 120, 130 on either lateral side 111, 112 of the elongated spine 110 may weight the device 100 to the saddle rack 5. Further, as shown in FIGS. 6-7 in particular, non-slip material may be utilized on both of the pair of cushion portions 120, 130 (‘second non-slip material’) as well as the elongated spine 110 (‘first non-slip material’), to aid in grip of the device 100 on the saddle rack 5.

Particularly, as shown in FIGS. 6-7, a bottom side 131 a, 131 b of each of the pair of cushion portions 120, 130 (i.e., the side contacting the saddle rack 5 when installed thereover) may include a plurality of non-slip strips 124 a, 124 b arranged over a length of the pair of cushion portions 120, 130. Further, a bottom surface 114 of the elongated spine 110 (i.e., the surface contacting the saddle rack 5 when installed thereover) may, in some embodiments, include a strip of non-slip material 115 spanning a length thereof. In some examples, the non-slip material 124 a, 124 b and 115 may include (but is not limited to) silicone.

A top side 132 a, 132 b of each of the pair of cushion portions 120, 130 (i.e., the side contacting the saddle 10 when installed thereunder) and a bottom surface 114 (opposite a top surface 113) of the elongated spine 110 (i.e., the surface contacting the saddle 10 when installed thereunder) may include a smooth, easy slide and non-scratch material so as to not cause any damage to the saddle 10. Preferably, the device 100 may also be easily cleanable and easily transferred between saddle racks 5.

As discussed above, the pair of cushion portions 120, 130 may be inflatable to provide cushioning and support to the saddle 10. As such, each of the pair of cushion portions 120, 130 may include at least one interior air pocket 121 a, 121 b, at least one air valve 122 a, 122 b and at least one air channel 123 a, 123 b. The at least one air channel 123 a, 123 b may be configured to carry air introduced at the at least one air valve 122 a, 122 b to the at least one interior air pocket 121 a, 121 b, enabling the at least one interior air pocket 121 a, 121 b to be filled with a desired level of air (thereby inflating the pair of cushion portions 120, 130).

In particular, each of the pair of cushion portions 120, 130 may include three interior portioned air pockets 121 a, 121 b located therewithin. The three interior air pockets 121 a, 121 b may define an entirety of the cushion portions 120, 130 such that the entirety of the cushion portions 120, 130 are able to be inflated. In some embodiments, due to the curvature of the bottom edge 126 a, 126 b, the three interior air pockets 121 a, 121 b may include different shapes and sizes.

Further, each of the pair of cushion portions 120, 130 may include two air channels 123 a, 123 b. The air pockets 121 a, 121 b and the air channels 123 a, 123 b are shown via broken lines throughout the figures to demonstrate the interior positioning thereof. It should be appreciated that the air pockets 121 a, 121 b and the air channels 123 a, 123 b may not be visible from an exterior of the cushion portions 120, 130. The two air channels 123 a, 123 b may extend longitudinally over the top edge 125 a, 125 b of each of the pair of cushion portions 120, 130 and the bottom edge 126 a, 126 b of each of the pair of cushion portions 120, 130. For example, one air channel 123 a, 123 b at the top edge 125 a, 125 b and another air channel 123 a, 123 b at the bottom edge 126 a, 126 b.

As shown in FIG. 7 in particular, two air valves 122 a, 122 b may be located at a rear of the device 100. Particularly, one air valve 122 a may be located at a rear end 133 a of the first cushion portion 120; and another air valve 122 b may be located at a rear end 133 b of the second cushion portion 130. Air valve 122 a may be directly connected to the air channels 123 a located within the first cushion portion 120 and configured to (selectively) supply the air to the three interior air pockets 121 a located within the first cushion portion 120, thereby inflating the first cushion portion 120; and further configured to release air from the three interior air pockets 121 a, thereby deflating, or partially deflating, the first cushion portion 120.

Similarly, air valve 122 b may be directly connected to the air channels 123 b located within the second cushion portion 130 and configured to (selectively) supply the air to the three interior air pockets 121 b located within the second cushion portion 130, thereby inflating the second cushion portion 130; and further configured to release air from the three interior air pockets 121 b, thereby deflating, or partially deflating, the second cushion portion 130. In some embodiments, the air valves 122 a, 122 b may each be configured to connect with an inflation device (not illustrated) to supply the air to the three interior air pockets 121 a, 121 b.

The amount of air in the three interior air pockets 121 a, 121 b may be easily adjusted to accommodate all saddle rack 5 types and any English-style saddle 10. For example, a desired amount of air may be introduced at the air valves 122 a, 122 b; and/or a desired amount of air may be released of the three interior air pockets 121 a, 121 b through the valves 122 a, 122 b. The release may be accomplished by opening the one or more of the air valves 122 a, 122 b and pressing on one or more of the three interior air pockets 121 a, 121.

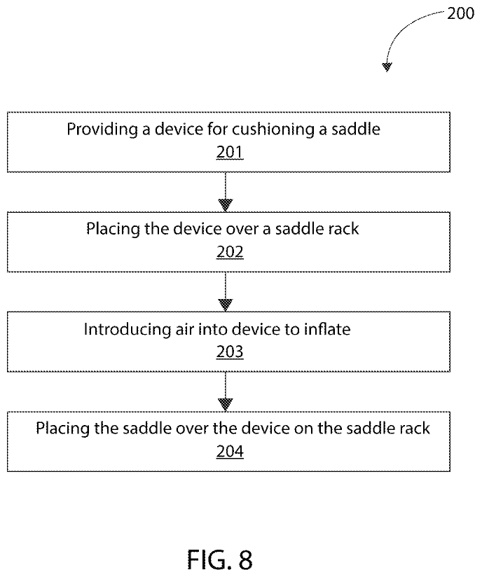

Referring now to FIG. 8 showing a flow diagram illustrating a method 200 of cushioning between a saddle and a saddle rack, according to an embodiment of the present disclosure. In particular, the method 200 may include one or more components or features of the device 100 as described above.

As illustrated, the method 200 may include the steps of: step one 201, providing the device as above; step two 202, placing the device over the saddle rack, oriented such that the elongated spine is positioned over a center of the saddle rack, a first cushion portion of the pair of cushion portions is positioned at a first side of the saddle rack, and a second cushion portion of the pair of cushion portions is positioned at a second side of the saddle rack; step three 203, introducing air through the at least one air valve on each of the pair of cushion portions, the air being carried through the at least one air channel of each of the pair of cushion portions and into the at least one interior air pocket of each of the pair of cushion portions, thereby inflating each of the pair of cushion portions; and step four 204, placing the saddle over the device, oriented such that the elongated spine is positioned under a seat of the saddle, the first cushion portion is positioned under a first side of the saddle, and the second cushion portion is positioned under a second side of the saddle.

It should be noted that some steps may not be implemented in all cases. It should also be noted that the steps described in the method of use can be carried out in many different orders according to user preference. The use of “step of” should not be interpreted as “step for”, in the claims herein and is not intended to invoke the provisions of 35 U.S.C. § 112 (f). It should also be noted that, under appropriate circumstances, considering such issues as design preference, user preferences, marketing preferences, cost, structural requirements, available materials, technological advances, etc., other methods are taught herein.

It should also be noted that, in this specification and the drawings, some elements that have substantially the same function and structure are denoted with the same reference signs, sometimes with the addition of subscripts for added clarity where needed, and repeated explanation omitted. It should also be appreciated that common but well understood elements that are useful or necessary in a commercially feasible embodiment are often not depicted throughout in order to facilitate a clearer view of the various embodiments of the present invention.

It should be understood by one of skill in the art that the disclosed invention is described here in a few exemplary embodiments of many. No particular terminology or description should be considered limiting on the disclosure or the scope of any claims issuing therefrom.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable relevant patent offices and the public generally, and especially the scientist, engineers and practitioners in the art who are not familiar with patent or legal terms or phraseology, to determine quickly from a cursory inspection the nature and essence of the technical disclosure of the application.

It should be appreciated that positional terms such as “upper”, “lower”, “top”, “bottom”, etc., are used for descriptive purposes and do not aim to restrict the scope of the description or claims. These terms serve the purpose of indicating relative positions as applied during the standard usage of the invention, facilitating a clearer explanation of its overall implementation. For example, “bottom surface,” refers generally to a surface facing downward during normal use of the invention.

What is claimed is:

1. A device for cushioning between a saddle and a saddle rack, the device comprising:
an elongated spine configured for placement between a center of the saddle rack and a seat of the saddle; and
a pair of cushion portions attached at opposite lateral sides of the elongated spine, a first cushion portion of the pair of cushion portions configured for placement between a first side of the saddle rack and a first side of the saddle, a second cushion portion of the pair of cushion portions configured for placement between a second side of the saddle rack and a second side of the saddle, the pair of cushion portions each including at least one interior air pocket, at least one air valve and at least one air channel configured to carry air introduced at the at least one valve to the at least one interior air pocket, thereby inflating each of the pair of cushion portions.

2. The device of claim 1, wherein the pair of cushion portions are pivotably attached to the elongated spine.

3. The device of claim 2, wherein the elongated spine is longitudinally flexible.

4. The device of claim 3, wherein the elongated spine is flat.

5. The device of claim 4, wherein each of the pair of cushion portions include three partitioned interior air pockets.

6. The device of claim 5, wherein each of the pair of cushion portions include one valve disposed at a rear end thereof.

7. The device of claim 6, wherein each of the pair of cushion portions include two longitudinal air channels, one disposed at a top edge thereof and another disposed at a bottom edge thereof.

8. The device of claim 7, wherein the elongated spine includes a first non-slip material at a bottom surface thereof.

9. The device of claim 8, wherein the first non-slip material spans a length of the elongated spine.

10. The device of claim 9, wherein each of the pair of cushion portions include a second non-slip material at a bottom side thereof.

11. The device of claim 10, wherein the second non-slip material includes a plurality of non-slip strips.

12. The device of claim 9, wherein the first non-slip material includes silicone.

13. The device of claim 11, wherein the second non-slip material includes silicone.

14. A device for cushioning between an English-style saddle and a saddle rack, the device comprising:
an elongated, longitudinally flexible spine configured for placement between a center of the saddle rack and a seat of the saddle, the elongated, longitudinally flexible spine including a first non-slip material located on a bottom surface thereof; and
a pair of cushion portions pivotably attached at opposite lateral sides of the elongated longitudinally flexible spine, a first cushion portion of the pair of cushion portions configured for placement between a first side of the saddle rack and a first side of the saddle, a second cushion portion of the pair of cushion portions configured for placement between a second side of the saddle rack and a second side of the saddle, each of the pair of cushion portions including three partitioned interior air pockets, a valve disposed at a rear end of each of the pair of cushion portions, two longitudinal air channels disposed at opposite top and bottom edges of each of the pair of cushion portions, and a second non-slip material located on a bottom side of each of the pair of cushion portions, the two longitudinal air channels in each of the pair of cushion portions configured to carry air introduced at each valve to the three partitioned interior air pockets in each of the pair of cushion portions, thereby inflating each of the pair of cushion portions.

15. The device of claim 14, wherein the first non-slip material spans a length of the elongated, longitudinally flexible spine.

16. The device of claim 15, wherein the second non-slip material includes a plurality of non-slip strips.

17. The device of claim 15, wherein the first non-slip material includes silicone.

18. The device of claim 16, wherein the second non-slip material includes silicone.

19. The device of claim 18, wherein the elongated spine is flat.

20. A method of cushioning between a saddle and a saddle rack, the method comprising the steps of:
providing a device for cushioning between the saddle rack and the saddle, the device including an elongated spine and a pair of cushion portions attached at opposite lateral sides of the elongated spine, the pair of cushion portions each having at least one interior air pocket, at least one air valve and at least one air channel;
placing the device over the saddle rack, oriented such that the elongated spine is positioned over a center of the saddle rack, a first cushion portion of the pair of cushion portions is positioned at a first side of the saddle rack, and a second cushion portion of the pair of cushion portions is positioned at a second side of the saddle rack;
introducing air through the at least one air valve on each of the pair of cushion portions, the air being carried through the at least one air channel of each of the pair of cushion portions and into the at least one interior air pocket of each of the pair of cushion portions, thereby inflating each of the pair of cushion portions; and
placing the saddle over the device, oriented such that the elongated spine is positioned under a seat of the saddle, the first cushion portion is positioned under a first side of the saddle, and the second cushion portion is positioned under a second side of the saddle.
